(19) United States
(12) Patent Application Publication
(10) Pub. No.: US 2025/0295179 A1
(43) Pub. Date: Sep. 25, 2025

(54) COLLAR PROTECTOR

(71) Applicant: Rhonda Rouget, Brooklyn, NY (US)

(72) Inventor: Rhonda Rouget, Brooklyn, NY (US)

(21) Appl. No.: 18/611,646

(22) Filed: Mar. 20, 2024

(51) Int. Cl. A41B 3/18; B32B 5/06; B32B 7/02; B32B 9/02; B32B 9/04; B32B 27/12; B32B 27/34; B32B 27/40

(52) U.S. Cl. CPC A41B 3/18; B32B 5/073; B32B 7/02; B32B 9/025; B32B 9/045; B32B 9/047; B32B 27/12; B32B 27/34; B32B 27/40; A41B 2400/62; B32B 2250/03; B32B 2307/726; B32B 2307/7265; B32B 2437/00

(57) ABSTRACT

According to some embodiments, a three-ply collar protector for insertion between a collar and a person includes a first absorbent material comprising a first absorbency, a second absorbent material comprising a second absorbency and a non-absorbent material configured for stopping moisture from passing. The first absorbent material is configured for contact with a person's skin. The second absorbent material is disposed between the first absorbent material and the non-absorbent material.

### BACKGROUND

When a person gets his/her hair cut, a stylist, or barber, often applies water to the person's hair and combs the hair backwards. This motion can cause moisture to drip back onto the person's collar or drop inside a person's shirt. Also, the same issue can happen when a stylist applies a product to a person's hair (e.g., treating the person's hair) and the product can stain or discolor the person's collar. Therefore, there is a need to be able to protect a person's collar during a haircut or a hair treatment.

### SUMMARY

Some embodiments described herein relate to a three-ply collar protector for insertion between a collar and a person. The three-ply collar protector includes a first absorbent material comprising a first absorbency, a second absorbent material comprising a second absorbency and a non-absorbent material configured for stopping moisture from passing. The first absorbent material is configured for contact with a person's skin. The second absorbent material is disposed between the first absorbent material and the non-absorbent material.

### BRIEF DESCRIPTION OF THE DRAWINGS

FIG. 1 illustrates a collar protector according to some embodiments.

FIG. 2 illustrates a collar protector according to some embodiments.

### DETAILED DESCRIPTION

In the following detailed description, numerous specific details are set forth to provide a thorough understanding of the embodiments. However, it will be understood by those of ordinary skill in the art that the embodiments may be practiced without these specific details. In other instances, well-known methods, procedures, and components have not been described in detail so as not to obscure the embodiments.

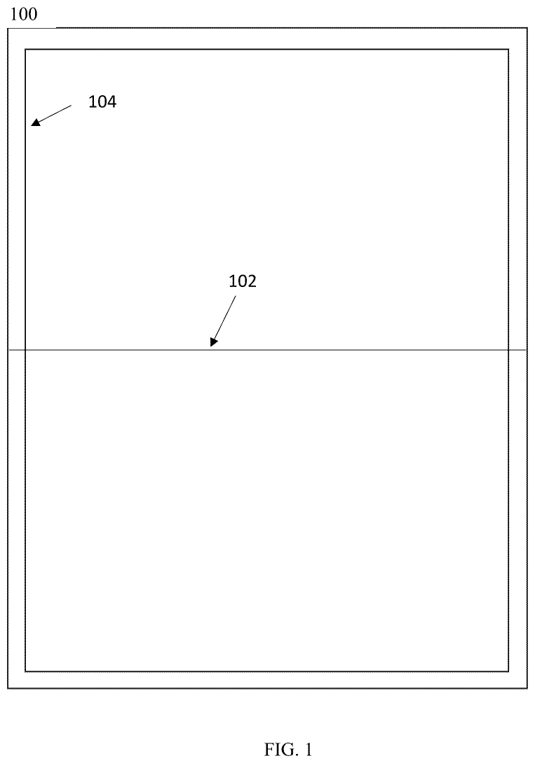

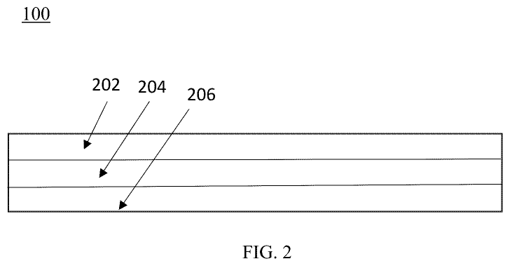

The present embodiments relate to novel collar protector that is configured to be both comfortable to a person getting their hair cut/treated and will also absorb moisture to protect the person's collar. Referring now to FIG. 1 and FIG. 2, a collar protector 100 is illustrated according to some embodiments. The collar protector 100 comprises at least three-plies and is configured for insertion between a collar (e.g. a clothing collar) and a person getting a haircut/treatment.

The collar protector 100 includes a first absorbent material 202 that comprises a first absorbency. The first absorbent material 202 is configured for contact with a person's skin. In other words, the first absorbent is a soft material designed to not irritate the skin of a person using the skin protector. In some embodiments, the first absorbent material 202 may comprise microfiber. Microfiber may comprise a plurality of synthetic fibers having a diameter of less than ten micrometers. In some embodiments, microfiber may be made of polyesters, polyamides, polypropylene, or combinations thereof. Microfiber may be able to absorb up to seven times its weight in liquid. In some embodiments, microfiber may absorb between one and seven times its weight in liquid. Microfiber, being so absorbent, can hold a lot of liquid without feeling heavy or damp which makes it conformable to a person when their skin is in contact with the microfiber (e.g., the first absorbent material 202).

The collar protector 100 includes a second absorbent material 204 that comprises a second absorbency. The second absorbent material 204 may be disposed between the first absorbent material 202 and a non-absorbent material 206. The second absorbent material 204 may have a greater absorbency than the first absorbent material 202. For example, the second absorbent material 204 may have an absorbency that is two to four times greater than the absorbency of the first absorbent material 202. This allows for moisture to be pulled away from the first absorbent material 202 to provide greater comfort to the person wearing the collar protector 100. In some embodiments, the second absorbent material 204 may be rougher on a person's skin than the first absorbent material 202.

In some embodiments, the second absorbent material 204 may comprise chamois. Chamois may be a porous leather made from a goatskin or sheepskin. Chamois may hold up to 30 times its weight in liquid. As such, the second absorbent material 204 may absorb at least three times its weight in liquid compared to the first absorbent material 202.

The non-absorbent material 206 may be configured for stopping moisture from passing through the collar protector 100. In some embodiments, the non-absorbent material 206 may comprise plastic, rubber or nylon thus keeping all moisture within the collar protector 100. In some embodiments, the non-absorbent material may comprise a polyurethane film that is bonded to a fabric. Therefore, with the two absorbent materials and a non-absorbent material, the collar protector makes up a three-ply collar protector 100.

The collar protector 100 may include first stitching 102 to divide the collar protector 100 into two equal portions for easy insertion between a person's collar and the person. The first stitching 102 makes it easier to fold the collar protector in half because it creates a natural bending location. A first half of the collar protector 100s may be disposed between the person's collar and the person and a second half of the collar protector may be disposed over the collar to protect the collar and absorb any moisture that may come of the person's hair. The collar protector 100 may further include second stitching 104 that circumscribes the collar protector 100 to connect all three layers together.

This written description uses examples to disclose multiple embodiments, including the preferred embodiments, and also to enable any person skilled in the art to practice the invention, including making and using any devices or systems and performing any incorporated methods. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

What is claimed:

1. A three-ply collar protector for insertion between a collar and a person, the three-ply collar protector comprising:
a first absorbent material comprising a first absorbency, where the first absorbent material is configured for contact with a person's skin;
a second absorbent material comprising a second absorbency and disposed between the first absorbent material and a non-absorbent material; and
the non-absorbent material configured for stopping moisture from passing.

2. The three-ply collar protector of claim 1, wherein the first absorbent material is microfiber.

3. The three-ply collar protector of claim 1, wherein the second absorbent material can absorb at least three times its weight in liquid compared to the first absorbent material.

4. The three-ply collar protector of claim 1, wherein the non-absorbent material is plastic or nylon.

5. The three-ply collar protector of claim 1, further comprising stitching to divide the three-ply collar protector into two equal portions for easy insertion between a collar and the person and to protect the collar.

6. The three-ply protector of claim 1, wherein the non-absorbent material is a polyurethane film bonded to a fabric.

7. The three-ply collar protector of claim 1, wherein the second absorbent material can absorb three times its weight in liquid.

8. A three-ply collar protector for insertion between a collar and a person, the three-ply collar protector comprising:
a first absorbent material comprising a first absorbency, where the first absorbent material is configured for contact with a person's skin and wherein the first absorbent material is microfiber;
a second absorbent material comprising a second absorbency and disposed between the first absorbent material and a non-absorbent material and wherein the second absorbent material is chamois;
the non-absorbent material configured for stopping moisture from passing wherein the non-absorbent material is a polyurethane film bonded to a fabric; and
stitching to divide the three-ply collar protector into two equal portions for easy insertion between a collar and the person.
